(19) United States
(12) Patent Application Publication
(10) Pub. No.: US 2004/0067163 A1
(43) Pub. Date: Apr. 8, 2004

(54) Chemical sensor based on the optical superprism effect in photonic crystals

(75) Inventors: Tushar Prasad, Houston, TX (US); Daniel Mittleman, Houston, TX (US); Vicki Colvin, Houston, TX (US)

Correspondence Address: CONLEY ROSE, P.C., P. O. BOX 3267, HOUSTON, TX, 77253-3267, US

(73) Assignee: William Marsh Rice University, Houston, TX (US)

(21) Appl. No.: 10/615,057

(22) Filed: Jul. 8, 2003

Related U.S. Application Data
(60) Provisional application No. 60/394,420, filed on Jul. 8, 2002.

(51) Int. Cl. G01N 21/00

(52) U.S. Cl. 422/58; 436/164

(57) ABSTRACT

A sensor comprising at least one photonic crystal, at least one light source capable of illuminating the crystal with a light beam having a predetermined wavelength and direction, and at least one position sensing detector positioned so as to detect the position of said light beam after it is transmitted by the crystal. Sensing is achieved by saturating the crystal with a liquid so as to produce a saturated crystal having a first refractive index, calculating for the crystal a dispersion surface and using the dispersion surface to calculate a effective incident light vector; and illuminating the saturated crystal with at least one light beam, the beam being incident substantially along the calculated effective incident light vector such that if the saturated crystal is modified to have a second refractive index, the position-sensing detector will detect a change in position of the transmitted light beam.

### CROSS-REFERENCE TO RELATED APPLICATIONS

The present application claims benefit of U.S. provisional application Serial No. 60/394,420, filed Jul. 8, 2002, and entitled “Chemical Sensor Based on the Optical Superprism Effect in Photonic Crystals,” which is incorporated herein by reference.

### STATEMENT REGARDING FEDERALLY SPONSORED RESEARCH OR DEVELOPMENT

Research leading to the present invention was supported in part by the federal government under grants Nos. CHE-967020 and CHE-0103174 awarded by the National Science Foundation. The United States government may have certain rights in the invention.

### TECHNICAL FIELD OF THE INVENTION

The present invention relates to methods and apparatus for sensing small quantities of analytes using optical techniques. By using a photonic crystal to contain a sample through which the light is transmitted and by sensing a change in the position of the transmitted light, the present invention provides an enhancement in sensitivity over other optical-based methods.

### BACKGROUND OF THE INVENTION

The present invention relates generally to sensors for chemical applications. A typical sensor consists of a responsive component that is altered or responds to the presence of a particular analyte, whose presence it is desired to detect, and a means for converting the response of the responsive element into an observable signal. In a chemical sensor, for example, the responsive component comprises a sensitive layer that is capable of binding the analyte reversibly and selectively and the converting means comprises a transducer that converts the variation of a physicochemical parameter during the binding of the analyte into a signal, which is generally electrical.

The sensitivity of a sensor is defined by its lower limit of detection, or the minimum amount or concentration of analyte that will induce an identifiable signal. In contrast, the selectivity of a sensor corresponds to its capacity to distinguish the desired analyte from other chemical species that may be present.

There are a variety of techniques for detecting chemical substances at low concentrations. For instance, single-pass absorption cell techniques have been used for species classification. Multi-pass cells may also be used for the detection of species at low concentration. Another technique is taught in U.S. Pat. No. 5,910,286, which discloses a chemical sensor having an acoustic wave transducer and a layer of a molecular fingerprint material, which allows the sensor to be highly selective. This molecular fingerprint material is a macroporous cross-linked product having cavities whose steric and functional configuration is specifically suited to capturing molecular or ionic species, or both.

U.S. Pat. No. 5,907,765 to Lescouzeres, et. al. discloses a method of patterning a cavity over a semiconductor device in order to manufacture a chemical sensor. This method involves forming a sacrificial layer over a substrate followed by patterning and etching this layer so that a portion of it remains on the substrate. The substrate and the remaining portion of the sacrificial layer are then covered by an isolation layer over which a conductive layer is formed. The conductive layer serves a purpose of providing a heater for the sensor device. The remaining portion of the of the sacrificial layer is then selectively etched away forming a cavity between the isolation layer and the substrate. This cavity provides thermal isolation between the heater and the substrate.

U.S. Pat. No. 5,866,430 to Grow discusses methods and devices for detecting, identifying and monitoring chemical or microbial species using the techniques of Raman scattering. The methodology disclosed therein includes four steps: (a) the gas or liquid to be analyzed or monitored is brought into a contact with a bioconcentrator, the latter being used for binding with the species or for collection or concentration of the species; (b) the bioconcentrator-species complex is irradiated at one or more predetermined wavelengths to produce the Raman scattering spectral bands; (c) the Raman spectral bands are processed to obtain an electric signal; and (d) the electric signal is processed to detect and identify the species, quantitatively, qualitatively, or both.

U.S. Pat. No. 5,835,231 to Pipino discloses a chemical sensor that detects chemicals through the use of a small, extremely low-loss, monolithic optical cavity fabricated from highly transparent, polygonally shaped optical material. In this invention optical radiation enters and exits the monolithic cavity by photon tunneling in which two totally reflecting surfaces are brought in a close proximity. In the presence of an absorbing material, the loss per pass is increased and the decay rate of an injected pulse is determined. The change in decay rate is used to obtain a quantitative sensor.

U.S. Pat. No. 5,744,902 to Vig discloses a sensor formed from a coated array of microresonators. Mass and temperature changes due to the presence of a particular substance cause a change in output frequency, which change is linked to the analyzed species. Furthermore, the change in frequency output due to the mass loading is distinguished from the change due to the temperature change.

Despite the foregoing advances, there remains a need for a very precise sensor that is compact, precise, selective, and sensitive. The development of three-dimensional photonic crystals with stop bands in the visible and near-infrared has attracted much attention recently, in part because of their potential value in optical sensing applications. Again, however, these applications have been either based on changes in wavelength or have produced only very small responses in the sensing material.

### SUMMARY OF THE INVENTION

The present invention provides a compact sensor that is precise, selective, and sensitive. The present sensing device is based on a detection and measurement of the angular deflection of a light beam, rather than its spectral properties. The present sensors exploit the superprism phenomenon, which causes a large deflection of a light beam in a photonic crystal when the incident angle of the light changes only slightly. Because the propagation direction of a light ray inside a photonic crystal can be extremely sensitive to the material parameters of the crystal, this scheme offers several advantages.

Sensors constructed in accordance with the present invention comprise a photonic crystal, a light source and a photosensor. When incident light from the light source is delivered at a predetermined angle with respect to the ordered array of colloidal particles comprising the crystal, the light is refracted substantially. The resulting shift in position of the resulting transmitted beam can be readily detected. The material from which the crystal is formed and the wavelength of the incident light are preferably selected such that the degree to which the beam is refracted is a function of the concentration of a predetermined analyte in a solution that is present within the crystal.

One advantage of the present invention is that position-sensitive detectors that are capable of very high resolution are readily commercially available. This contrasts with the relative lack of resolution of wavelength-based sensors, which depend on sensing small changes in the spectrum of diffracted or emitted radiation. Still another advantage of the present sensors is that the position-sensitive detector(s) can be positioned directly adjacent to the photonic crystal, with the result that the sensor assembly can be compact.

The present sensors are expected to be able to detect very small quantities of the compound in question.

### BRIEF DESCRIPTION OF THE DRAWINGS

For a more detailed understanding of the invention, reference is made to the accompanying drawings, in which:

FIG. 1 is a schematic diagram of an assembly forming a sensor in accordance with the present invention;

FIG. 2 shows a band structure for a hypothetical photonic crystal;

FIG. 3 shows two examples of calculated dispersion surfaces, at energies corresponding to the dashed lines in FIG. 2, namely Ω=0.80 and Ω=0.73; and

FIG. 4 is a plot of the magnitude of the beam displacement as a function of refractive index at several different wavelengths for a single incident angle.

### DETAILED DESCRIPTION OF THE PREFERRED EMBODIMENTS

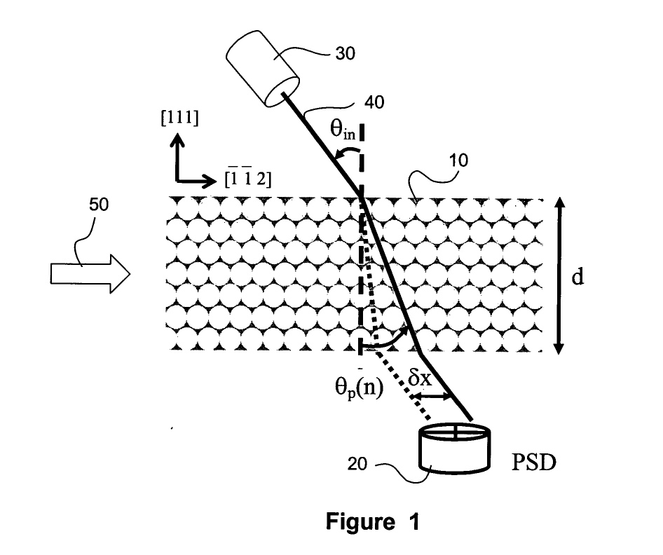

Referring initially to FIG. 1, an exemplary configuration for the components of a sensor constructed in accordance with the present invention includes a photonic crystal 10, a position-sensing detector (PSD) 20, and a light source 30 that projects a light beam 40.

Photonic crystal 10 is preferably macroporous film comprising a three-dimensional array of spherical voids in a matrix. Photonic crystal 10 is preferably formed by templating a face-centered cubic (fcc) crystal of sub-micron spheres. Once the template is formed, the spheres are removed, leaving an fcc lattice of interconnected air-filled spheres defined by a matrix. One preferred technique for forming such a crystal is described in U.S. application Ser. No. 09/992,084, filed Nov. 19, 2001, and entitled, “Polymers Having Ordered, Monodisperse Pores and Their Corresponding Ordered Monodisperse Colloids,” which is incorporated herein in its entirety. According to a preferred embodiment described therein, the photonic crystal comprises a porous polymer prepared by polymerization of one or more polymerizable components around a colloidal template followed by the selective removal of said colloidal template. The colloidal template is preferably an ordered, monodisperse colloidal template so that the resulting porous polymer will be an ordered, monodisperse macroporous polymer. The ordered, monodisperse macroporous polymer forming the matrix preferably comprises a material selected from the group consisting of poly(methyl methacrylate), poly(allyl)methacrylate (PAMA), and polystyrene. In other embodiments, any suitable, matrix material is used, including but not limited to polymers, ceramics, metals, metal oxides, and mixtures thereof. An advantage of the present macroporous systems is their wide versatility with respect to the composition of the film.

Once the template is removed the remaining matrix forms photonic crystal 10, which includes a plurality of ordered micropores. According to the present invention, this porous crystal can be used to detect minute changes in composition of a solution that fills its pores. While the crystal can be saturated with the solution in any suitable manner, in one preferred embodiment the solution is continuously flowed through the crystal, as indicated for example by arrow 50. Thus the present sensors can be used to continuously monitor the composition of a stream. In another embodiment, the solution to be monitored can be placed in the pores of the crystal by dipping the crystal in the solution, by dropwise application of the solution, or any other suitable technique.

Using the crystal structure, template size, and refractive index of the matrix, and the measured or known refractive index of the solution, the band structure of the crystal can be calculated. From the full band structure, all possible values of wave vectors in the three-dimensional space for a particular energy can be calculated using algorithms that are known in the art. A plot of all these wave vectors in k-space for a particular energy gives an equal-energy surface known as a dispersion surface. The shape of the dispersion surface depends on the chosen value of the energy, specified by the frequency of the incident light. For small values, far from the stop band, the band structure is isotropic in nature. In this case, the dispersion surface is spherical with a radius given by c/navg, where navg is the average (homogenized) refractive index. At higher energy values, near the photonic band gap, the band structure becomes anisotropic. As a result, the shape of the dispersion surface deviates from spherical, although it retains the symmetry of the Brillouin zone.

Using the calculated dispersion surface it is possible to compute the input-output characteristics for any input ray. Specifically, it is possible to determine an incident light vector for which the gradient of the dispersion surface, which determines the propagation direction, of that particular crystal will change non-linearly as a function of the refractive index of the solution. One approach is to compute the output ray for a large number of input rays and then pick the one that has the largest nonlinear response. The light source 30 and crystal 10 are then positioned relative to each other so that light beam 40 impinges on crystal 10 substantially along the predetermined incident light vector. In this manner, the superprism effect of the crystal is used to increase the sensitivity of the sensor to changes in the composition of the solution.

Further details regarding operation of such a device and the underlying calculations entailed in quantifying the response of the crystal can be found in T. Prasad, V. Colvin, and D. Mittleman, “The Superprism Phenomenon in Three-Dimensional Macroporous Polymer Photonic Crystals,”, Phys. Rev. B, 67, 165103 (2003); R. Rengarajan, P. Jiang, D. Larrabee, V. Colvin, and D. Mittleman, “Colloidal Photonic Superlattices,” Physical Review B, 64, 205103 (2001); P. Jiang, G. N. Ostojic, R. Narat, D. Mittleman, and V. Colvin, “The Fabrication and Band Gap Engineering of Photonic Multilayers,” Advanced Materials, 13, 389 (2001); Peng Jiang, Jane F. Bertone, Vicki L. Colvin, “A Lost Wax Approach to Monodisperse Colloids and Their Crystals”, Science, 291, 2001, 453-457; R. Rengarajan, P. Jiang, V. Colvin, and D. Mittleman, “Optical Properties of a Photonic Crystal of Hollow Spherical Shells,” Applied Physics Letters, 77, 3517 (2000); D. M. Mittleman, J. F. Bertone, P. Jiang, K. S. Hwang, and V. L. Colvin, “Optical Properties of Planar Colloidal Crystals: Dynamical Diffraction and the Scalar Wave Approximation,” Journal of Chemical Physics, 111, 345 (1999); J. F. Bertone, P. Jiang, K. S. Hwang, D. M. Mittleman, and V. L. Colvin, “Thickness Dependence of the Optical Properties of Ordered Silica-Air and Air-Polymer Photonic Crystals,” Physical Review Letters, 83, 300 (1999); and P. Jiang, J. F. Bertone, K. S. Hwang, D. M. Mittleman, and V. L. Colvin, “Template-Directed Preparation of Macroporous Polymers with Oriented and Crystalline Arrays of Voids,” Journal of the American Chemical Society, 121, 11630 (1999), each of which is incorporated herein by reference.

### EXAMPLES

The Examples below are merely intended to illustrate some of the principles of the present invention and are not intended to limit the scope of the invention in any way.

For purposes of illustration, a photonic crystal was assumed to be constructed of a dielectric material having a refractive index of 1.59 (similar to polystyrene). This band structure accounts for the windows that are formed between pairs of adjacent voids when the voids overlap slightly, e.g. r/a=0.53, wherein r is the radius of the spherical voids, and a is the fcc lattice parameter. When r/a>0.5, the centers of any two adjacent spherical voids are slightly closer together than one diameter, which means that the spheres overlap slightly, which in turn results in a “window” connecting adjacent voids in the crystal. This structural feature must be accounted for when band structure is computed. In the modeling discussed below, the film thickness is assumed to be 10 microns, which is easily achieved using the film fabrication methods mentioned above.

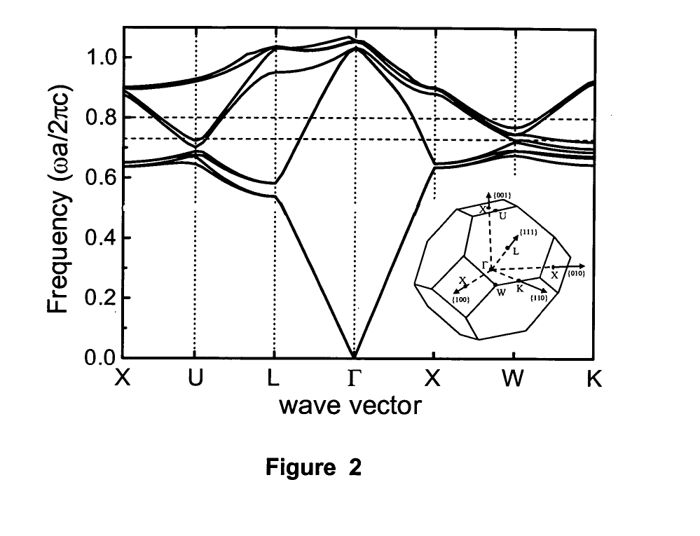

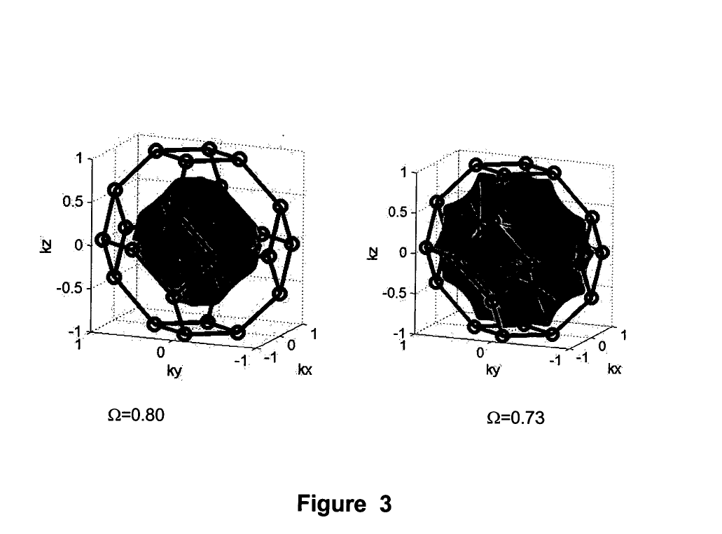

FIG. 2 shows a band structure for this hypothetical crystal in the standard format, in which only the high symmetry directions are represented. The lowest eight bands in the band structure of the inverted fcc photonic crystal lattice are computed using the plane wave method. The horizontal dashed lines represent the energies used to compute the dispersion surfaces shown in FIG. 3. The inset shows the first Brillouin zone of the fcc lattice, with various high symmetry points labeled.

Though the modeled structure does not provide a high enough dielectric contrast for the formation of a full band gap, it does possess a substantial stop band indicative of a partial gap along the [111] crystalline axis. This is an indication of strong band structure anisotropy, which is sufficient for the observation of the superprism effect. While FIG. 2 displays only a partial band structure, in order to perform the computation described below it is necessary to compute a complete band structure. Specifically, the band structure must be calculated from Γ to all possible points on the surface of the Brillouin zone, rather than merely the high symmetry points. Nonetheless, the symmetry of the Brillouin zone can be used to reduce the computational load.

From the full band structure, the dispersion surface can be calculated. As mentioned above, the shape of the dispersion surface depends on the chosen value of the energy, specified by the frequency of the incident light. For small values, far from the stop band, the band structure is isotropic in nature. In this case, the dispersion surface is spherical with a radius given by c/n_{avg}, where n_{avg} is the average (homogenized) refractive index. At higher energy values, near the photonic band gap, the band structure becomes anisotropic. As a result, the shape of the dispersion surface deviates from spherical, although it retains the symmetry of the Brillouin zone. Two examples of iso-energy (dispersion) surfaces computed from the full three-dimensional photonic band structure corresponding to the dashed lines in FIG. 2, are shown in FIG. 3. FIG. 3(A) is calculated for Ω=0.80 and FIG. 3(B) is calculated for Ω=0.73.

Once the dispersion surface is calculated, the propagation direction inside the crystal can be calculated for an incident light ray having a given angle of incidence. It should be noted that, because of the anisotropy of the crystal, the direction of the incident light must be given as a vector. The propagation direction is obtained by computing the normal to the dispersion surface at the end point of the propagation wave vector, since the group velocity is given by v_{G}=∇ₖΩ(k). This point is defined by the transverse component of the wave vector along with the direction of the incident ray. If the dispersion surface is spherical, the gradient points radially and the wave propagates in the direction parallel to its wave vector. As a result, the propagation angle does not change drastically for small changes in the incident orientation or incident wavelength. If the dispersion surface is distorted, however, the gradient can become more sensitive to changes in the incident angle.

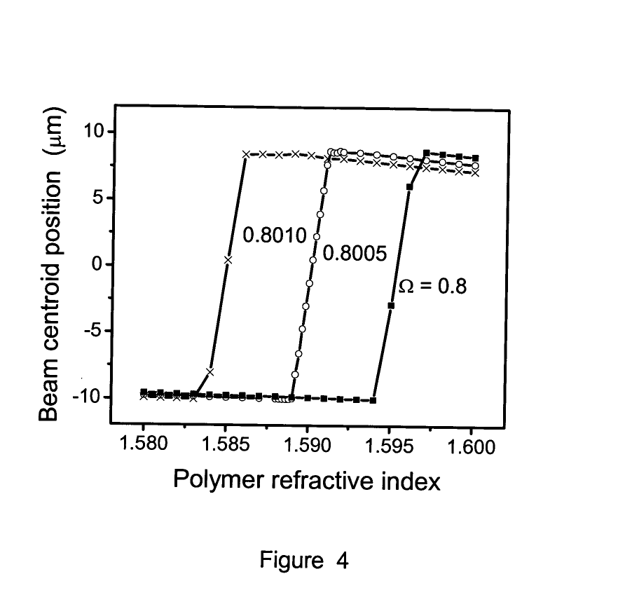

Once the internal propagation direction is determined, it is possible to compute the shift in the position of the transmitted ray if the geometry of the sample is specified. Using this information, it is possible to determine an optimum angle and frequency for an incoming light beam that can be used effectively to indicate changes in the photonic crystal. By way of example, the magnitude of the beam displacement as a function of refractive index was calculated for two different incident angles and at several different wavelengths. The results of these calculations are plotted FIG. 4. In FIG. 4 the incident angle is 39°. The incident angle θᵢₙ is specified relative to the [111] axis (the surface normal). This axis and the incident k vector lie in the plane of the paper as shown in FIG. 4. The change in displacement is plotted relative to the displacement that would occur at the same wavelength in a matrix having a refractive index of 1.59, which is the refractive index of polystyrene.

The resulting plots show that at certain frequencies and incident angles, the beam displacement changes drastically over a narrow range of refractive indices. Specifically, shifts of 5-10 microns can be expected for refractive index changes smaller than 1%, depending on the wavelength of the incident beam. Position-sensing devices that can detect changes in beam position resulting from refractive index shifts as low as a few parts in 10⁴, and more preferably as a few parts in 10⁵, are believed to be possible using currently available technology. The latter represents a factor of improvement of about 1000 as compared to previous optical sensing techniques. The performance of the present system is sensitive to the wavelength of the incident light. For example, for the configuration shown in FIG. 4, if the spheres have a diameter of ˜400 nm, the three specified wavelengths are spaced by ˜0.3 nanometers. This level of spectral purity is achievable using a variety of commercial laser sources.

Referring again now to FIG. 1, computations of this type can be used in conjunction with a sensor in accordance with the present invention. When the photonic crystal 10 is saturated with a solution, its refractive index will depend in part on the chemical composition of that solution. If the composition of the solution changes, such as for example when the concentration of a particular analyte in the solution changes, the refractive index of the crystal containing the solution will also change. If the wavelength and direction of the incident light have been set in accordance with the principles described herein, the position of the beam detected at the position-sensing detector will shift markedly, allowing the detector to detect the change and thus resulting in a sensitive and effective sensor.

In one embodiment of the invention, the photonic crystal can include one or more chemical additives that increase the affinity of the crystal for one or more desired analytes. The analyte-attracting or analyte-binding moiety or moieties can be included in the polymer composition itself, or can be added after formation of the crystal. In the latter case, the analyte-attracting moiety is preferably chemically bonded to the material of the crystal in order to prevent it from being washed from the crystal by the solution that is being analyzed. Molecules that are useful for attracting and/or binding desired species are known in the art. For example, an exemplary list of such compounds is given in U.S. Pat. No. 6,586,256, which is incorporated herein by reference. The additive is preferably covalently bound to the crystal.

In another embodiment of the present sensors, an array of incident beams and associated PSDs can be provided, with the incident beams each being arranged and tuned such that each beam/detector pair is sensitive to composition changes in a different range of concentrations of the desired analyte. In a sensor configured in this manner, if the concentration of analyte is within the range of concentrations that can be sensed by the array, at least one PSD will detect a change in beam position and the concentration of the analyte can be determined from either the identity of that PSD or the degree of change of beam position, or both.

The present sensors rely on the sensitivity of the propagation angle of light in a photonic crystal, rather than on its spectral properties. Because the technique relies on the superprism effect in three-dimensional templated photonic crystals, which can be fabricated from a wide variety of materials, the present sensors provide a wide versatility with respect to the nature of the sensing application. In addition, because the position of the transmitted laser beam can be measured with extreme precision, the present sensing techniques are expected to substantially increase the sensitivity of optical sensing methods.

The present invention provides compact devices for remotely detecting the presence of chemical or biological agents and provides a degree of sensitivity not previously available in this context. This invention allows one to detect the presence of chemical and biological agents even at a very low concentration.

While the present invention has been disclosed and described with respect to certain preferred embodiments, these embodiments are not intended to limit the scope of the claims in any way. Various modifications to the apparatus described herein can be made. For example, the materials from which the crystal are made can vary, the source and wavelength of the incident light can be modified, the type of position-sensing detector can be varied, and the techniques for calculating the optical properties of the crystal can be modified. Further, the sequential recitation of steps in the claims that follow is not intended as a requirement that the steps be performed in any particular order, or that any step be completed before the next is begun.

What is claimed is:

1. A sensor for detecting the presence of an analyte in a solution, comprising:
a photonic crystal;
a light source capable of illuminating the crystal with a light beam having a predetermined wavelength and direction; and
a position sensing detector positioned so as to detect the position of the light beam after it is transmitted by the crystal.

2. The sensor according to claim 1 wherein said photonic crystal comprises a porous polymer prepared by polymerization of one or more polymerizable components around a colloidal template followed by the selective removal of said colloidal template.

3. The sensor according to claim 2 wherein said colloidal template is an ordered, monodisperse colloidal template and said porous polymer is an ordered, monodisperse macroporous polymer.

4. The sensor according to claim 3 wherein said ordered, monodisperse macroporous polymer comprises a material selected from the group consisting of poly(methyl methacrylate) and polystyrene.

5. The sensor according to claim 1 wherein said photonic crystal is selected and said light source is selected and positioned so as to create cause a displacement of said light beam of at least 2 μm when the refractive index of said photonic crystal changes by 0.002.

6. The sensor according to claim 1 wherein said photonic crystal is selected and said light source is selected and positioned so as to create cause a displacement of said light beam of at least 4 μm when the refractive index of said photonic crystal changes by 0.002.

7. A kit capable of being assembled to provide a sensor for detecting the presence of an analyte in a solution, comprising:
a photonic crystal or kit for making a photonic crystal;
a light source capable of illuminating the crystal with a light beam having a predetermined wavelength and direction; and
a position sensing detector capable of being positioned so as to detect the position of a light beam from the light source after it is transmitted by the crystal.

8. The kit according to claim 7 wherein said photonic crystal comprises a porous polymer prepared by polymerization of one or more polymerizable components around a colloidal template followed by the selective removal of said colloidal template.

9. The kit according to claim 7 wherein said colloidal template is an ordered, monodisperse colloidal template and said porous polymer is an ordered, monodisperse macroporous polymer.

10. The kit according to claim 9 wherein said ordered, monodisperse macroporous polymer comprises a material selected from the group consisting of poly(methyl methacrylate) and polystyrene.

11. A method for sensing, comprising the steps of:
a) providing a sensor comprising at least one photonic crystal, at least one light source capable of illuminating the crystal with a light beam having a predetermined wavelength and direction, and at least one position sensing detector positioned so as to detect the position of said light beam after it is transmitted by the crystal;
b) saturating the crystal with a liquid so as to produce a saturated crystal having a first refractive index;
c) calculating for the photonic crystal a dispersion surface and using the dispersion surface to calculate a effective incident light vector; and
c) illuminating the saturated crystal with at least one light beam, the beam being incident along substantially the calculated effective incident light vector such that if the saturated crystal is modified to have a second refractive index, the position-sensing detector will detect a change in position of the transmitted light beam.

12. The method according to claim 11, further including the step of selecting the light beam to have a predetermined wavelength.

13. The method according to claim 11 wherein step c) includes calculating the propagation direction inside the crystal for at least one incident light ray.

14. The method according to claim 11, wherein step a) includes providing an array of light sources, each light source having an associated position-sensing detector, and at least one photonic crystal positioned between said light sources and said associated position-sensing detectors.
